(19) United States
(12) Patent Application Publication
(10) Pub. No.: US 2018/0215636 A1
(43) Pub. Date: Aug. 2, 2018

(54) Dendritic polymer heavy metal precipitant with double functions of chelation and self-flocculation and its application

(71) Applicant: Tongji University, Shanghai (CN)

(72) Inventors: Bingru Zhang, Shanghai (CN); Fengting Li, Shanghai (CN); Ying Wang, Shanghai (CN); Chunrou Wu, Shanghai (CN); Manling Zhang, Shanghai (CN); Yankai Zhao, Shanghai (CN)

(73) Assignee: Tongji University

(21) Appl. No.: 15/936,433

(22) Filed: Mar. 27, 2018

(30) Foreign Application Priority Data
Mar. 31, 2017 (CN) 201710205275.2

(51) Int. Cl. C02F 1/68; C08G 83/00; B01D 15/38; B01D 21/01

(52) U.S. Cl. CPC C02F 1/683; C08G 83/004; B01D 2257/60; B01D 21/01; B01D 15/38

(57) ABSTRACT

Dendritic polymer heavy metal precipitant with double functions of chelation and self-flocculation and its application is provided. The heavy metal precipitant is dithiocarbamates end group polyamidoamine dendritic polymer prepared by reaction of carbon bisulfide and polyamidoamine dendritic polymer with a generation at a range of 1-3 (denoted as PAMAM-(NH2)_{8G}, wherein G is generation number). Due to the special three dimensional spatial structure, appropriate molecular weight, high density of the end chelating group dithiocarbamates, the dithiocarbamates end group polyamidoamine dendritic polymer of the present invention not only has strong chelating performance with the heavy metal iron, the sediment floc formed has a large volume, a fast sedimentation velocity and easy separation. The present invention has high efficiency performance in chelating and flocculating heavy metals.

### CROSS REFERENCE OF RELATED APPLICATION

The present application claims priority under 35 U.S.C. 119(a-d) to CN 201710205275.2, filed Mar. 31, 2017.

### BACKGROUND OF THE PRESENT INVENTION

### Field of Invention

The present invention relates to the field of environmental protection technique, and more particularly to a dendritic polymer heavy metal precipitant with double functions of chelation and self-flocculation and its application. The heavy metal precipitant is dithiocarbamates end group polyamidoamine dendrimer which has end chelate groups of dithiocarbamates with a generation amount of 8 times that of the G, wherein G is generation number G≠0, G=1-3.

### Description of Related Arts

Heavy metal wastewater treatment method mainly includes chemical precipitation method, ion exchange method, reverse osmosis method and active carbon adsorption method, wherein the chemical precipitation method has a relative low cost, a relative simple technique, a simple technique, a mature technique, and thus is most widely used.

The conventional chemical precipitation method mainly includes neutralization precipitation method and sulfide precipitation method.

The neutralization precipitation method refers to adding alkaline chemicals to the heavy metals wastewater to perform a neutralization reaction, so that the heavy metals will form water-insoluble hydroxide precipitates to be removed.

The neutralization precipitation method has a low cost, but there are some drawbacks as follows. (1) Since the wastewater often contains various kinds of heavy metals, when amphoteric metals such as Zn, Pb, Sn and Al are contained, if pH is low, precipitation is difficult to form; if pH is high, the amphoteric metals are tended to re-dissolve. Thus, pH needs to be accurately adjusted to perform the step-by-step precipitation treatment so as to ensure the best removal effect and to make the treatment process more complicated. (2) If the pH is not well controlled, colloid is easy formed. (3) The pH of the treated wastewater often reaches 10 or more, and it must be neutralized before it can be discharged. The acid-base consumption is high. (4) The complex state heavy metals cannot be removed and complex breaking pretreatment combining with oxidation reduction process is needed. (5) The hydroxide precipitate generated dissolves again with the reduction of pH, resulting in secondary pollution.

The pH of sulfide precipitation method is about 9, wherein sulfide, such as sodium sulfide or sodium hydrosulfide, is added to make the heavy metals to generate sulfide precipitation which is insoluble in water to be removed. Compared with the neutralization precipitation method, the solubility of heavy metal sulfide is lower than the hydroxide of heavy metal sulfide and the residual of heavy metal is lower. However, sulfide precipitation method is small, with a slow sedimentation rate and is easy residue; the residual precipitation can generate hydrogen sulfide gas when encounters acid, resulting in secondary pollution.

The heavy metal waste water treated by the conventional chemical method of the neutralization precipitation method and the sulfide precipitation method is often difficult to reach the discharge standard.

In view of the problems of the conventional chemical precipitation method, dithiocarbamate (DTC) organic heavy metal precipitant have developed in recent years. The DTC heavy metal precipitant can form stable precipitation with heavy metals that is insoluble in water, and the heavy metal content in the treated water is much lower than the traditional precipitation treatment method.

According to the molecular structure, the DTC heavy metal precipitant can be classified into two types: DTC linear polymer heavy metal precipitant and DTC small molecule heavy metal precipitant. The DTC linear polymer heavy metal precipitant is formed by connecting the amine on the linear chain of linear polymers with the grafted dithiocarboxylates, e.g., polyethyleneimine (Chinese Patent Publication No. CN101081827A), polyacrylamide (Chinese Patent Publication No. CN11979416B), starch (Chinese Patent Publication No. CN 101759809B), and the like is connected with the grafted dithiocarbamates to form DTC linear polymer heavy metal precipitant. DTC small molecule heavy metal precipitant is formed by connecting small molecular amine compound and dithionate, such as connecting ethylenediamine (Chinese Patent Publication No. CN101857296B), piperazine (China Invention Patent CN 102216410B), melamine (China Invention Patent CN 103224472A) or the like with dithionate to form DCT small molecule heavy metal precipitant.

DTC linear polymer heavy metal precipitant has a better performance in self-flocculation and sedimentation, but the molecular chain of the linear polymer is easy to crimp, especially under acidic and neutral conditions, which causes a result that the DTC group is hidden inside the molecular chain and the chelating efficiency of the DTC and heavy metals is decreased. Small molecule DTC heavy metal precipitant, although has a high chelating efficiency with heavy metals, the chelating deposition formed is small, with a low sedimentation velocity, the adding flocculants is required to achieve the rapid sedimentation purposes. So heavy metal precipitant with double functions of chelation and self-flocculation becomes the urgent requirement in heavy metal processing.

In recent years, compared with the linear polymer, as new three-dimensional dendrimers, dendritic polymer has structural characteristics of a precise molecular structure, a high degree of geometrical symmetry, a large number of functional groups in the periphery, a cavity in the molecule, and a relative controllable molecular mass, a nano-size in the molecule itself and etc. Polymeric polyamide-amine (PAMAM), as a representative of dendritic polymers, attracts more and more attention. In view of the fact that the PAMAM product of the whole generations has a large number of amine ends and a rigid, non-crimpable property, the PAMAM is capable connecting with dithionate to form a new class of DTC dendritic polymer heavy metal precipitant.

The applicants of the present invention disclosed a dithiocarbamate functionalized 0-generation polyamide amine-terminal dithiocarbamate-based 0-generation polyamidoamine in Chinese Patent Publication No. CN103864654B. The polymer has a two-dimensional planar quadrilateral structure, the floc particles are large, and the self-flocculation and sedimentation performance is greatly improved compared with the DTC small molecule heavy metal trapping agent, but the floc density is not high. The sedimentation velocity is less than the DTC linear polymer heavy metal precipitant.

### SUMMARY OF THE PRESENT INVENTION

An object of the present invention is to overcome the short comings in the conventional DTC derivative chelating for heavy metals and provide a heavy metal precipitant with double functions of chelation and self-flocculation, wherein the heavy metal precipitant combines the advantages of the high chelating efficiency in small-molecular DTC derivative heavy metal precipitant and the high sedimentation velocity in DTC derivative linear polymers heavy metal precipitant.

In order to achieve the objects mentioned above, the present invention provides a heavy metal precipitant.

The dendritic-polymer heavy metal precipitant with double functions of chelation and self-flocculation, which is denoted as (PAMAM-(NHCSSNa)_{8G}, is provided, wherein the heavy metal precipitant is dithiocarbamates (DTC) end group polyamidoamine dendritic polymer, an amount of the dithiocarbamates which are end chelate groups of the heavy metal precipitant, is 8 times that of the G (G represents generation, G≠0, G=1-3), wherein a structural formula of the (PAMAM-(NHCSSNa)_{8G} is as shown in formula I:

wherein “A” represents a core which is specified as [N(CH₂)_{2˜12}N]; “—” represents a branched chain which is specified as [CH₂CH₂CONHCH₂CH₂]; “N” represents an internal branched atom which is specified as a nitrogen atom; “G” represents generation which is specified as a positive number between 1-3.

In the present invention, the dendritic-polymer heavy metal precipitant with double functions of chelation and self-flocculation, which is shown in the formula I, is prepared by a reaction of a raw material of polyamidoamine has terminal amine groups, with an amount of 8 times that of the G (G≠0, G=1-3), denoted as PAMAM-(NH₂)_{8G}, and carbon bisulfide; wherein the amount of the terminal amine groups is 8 times that of the G (G≠0, G=1-3); a structural formula is as shown in formula II:

wherein “A” represents a core which is specified as [N(CH₂)_{2˜12}N]; “—” represents a branched chain which is specified as [CH₂CH₂CONHCH₂CH₂]; “N” represents an internal branched atom which is specified as a nitrogen atom; “G” represents generations which is specified as a positive number between 1-3.

In the present invention, a specific preparing process of the dithiocarbamates (DTC) end group polyamidoamine dendritic polymer, i.e., (PAMAM-(NHCSSNa)_{8G}, comprises steps as follows.

(1) Additive Reaction:

adding ethanol solution of polyamidoamine with a generation G at a range of 1-3 (PAMAM-(NH₂)_{8G}, G≠0, G=1-3) to a reactor, passing through nitrogen, decreasing a temperature to 5-10° C., slowly adding overdose methanol solution of carbon bisulfide drop by drop, controlling adding rate, so that temperature of reaction mixture is at a range of 5-10° C.; increasing the temperature to 25° C. when the adding is finished; keeping reaction for 1-5 hours, white precipitation emerges, filtering to obtain formyloxy dithiocarbamates end group polyamidoamine (PAMAM-(NHCSSH)_{8G}), wherein mother liquid is methanol and carbon disulfide failing to react and can be used for a next addition reaction;

(2) Salt Forming Reaction

adding the (PAMAM-(NHCSSH)_{8G}) obtained in the step (1) to a reactor, adding aqueous solution of sodium hydroxide, reacting for 1-3 hours at 40-60° C. to obtain dithiocarbamates end group polyamidoamine (PAMAM-(NHCSSNa)_{8G}, which is denoted as PAMAM-(DTC)_{8G},

wherein a molar ratio of the reactants is: PAMAM-(NH₂)_{8G}: CS₂: NaOH=1:(20G˜30G): (6G-8G);

wherein reaction equation is as follows:

The polyamidoamine (PAMAM) with a generation G at a range of 1-3 (G≠0, G=1-3) adopted by the preferred embodiment of the present invention is commercially available from sigma-aldrich China; the carbon disulfide, sodium hydroxide, and methanol are commercially available products.

The present invention prepared dithiocarbamates end group polyamidoamine dendritic polymer (PAMAM-(DTC)_{8G}, G≠0 , G=1˜3), which forms flocculent precipitate with heavy metals, wherein particles are large in volume, compact, setting fast, and shows the ability of chelating heavy metals in high efficiency combining with performance of flocculating settling heavy metals.

The applicant discovers that dithiocarbamates end group polyamidoamine PAMAM-(DTC)₄) prepared by zero generation polyamidoamine (PAMAM-(NH₂)₄, G=0) forms self-flocculation deposition with heavy metals, wherein the self-flocculation deposition is flaky deposition which is loose and has a low deposition rate.

The applicant of the present invention discovers that (PAMAM-(DTC)_{8G}) prepared by polyamidoamine (PAMAM-(NH₂)_{8G}) G≥4 is capable of forming flocculent precipitate with heavy metals, with large particles, fast deposition rate, but the preparation cost is high and the application value is not high.

Due to the special spatial three-dimensional structure, the dithiocarbamates end group polyamidoamine dendritic polymer ((PAMAM-(DTC)_{8G}(G represents generation, G≠0, G=1-3) provided by the present invention special spatial≠(PAMAM-(DTC) 8G (G algebra, G three-dimensional structure, high-density end-group chelating groups dithiocarbamate (DTC) causes a strong binding force with heavy metals, which improves the chelating efficiency of heavy metal ions in wastewater. The flocculent deposition generated by (PAMAM-(DTC)_{8G} of the present invention is capable of producing large volume, dense, rapid deposition velocity flocculating precipitate with heavy metals, which shortens the sedimentation time, so that the concentration of residual heavy metal ions in the wastewater is capable of meeting the national emission standards below, secondary pollution is hard to generate. In addition the chelating of the present invention can also be applied in recycling precious metals in the aqueous solution, and has advantages of small addition amount and high chelating efficiency.

The dithiocarbamates end group polyamidoamine dendritic polymer (PAMAM-(DTC)_{8G}, G≠0, G=1˜3) of the present invention is suitable for wastewater treatment in electroplating, circuit board, film manufacturing, metal surface finishing, battery production, coal power plants and other industries. Meanwhile, the present invention is also suitable for stabilization treatment on industrial and domestic waste incineration fly ash and stabilization repair of heavy metal polluted farmland.

These and other objectives, features, and advantages of the present invention will become apparent from the following detailed description, the accompanying drawings, and the appended claims.

### DETAILED DESCRIPTION OF THE PREFERRED EMBODIMENT

Further description of the present invention is illustrated combining with the preferred embodiments. One skilled in the art will understand that the embodiment of the present invention as shown in the drawings and described above is exemplary only and not intended to be limiting.

Comparative example Preparation of 0-generation dithiocarbamates end group polyamidoamine dendritic polymer

129.17 g (20%, 0.05 mol) methanol solution of (Ethylenediamine core, 0 generation, PAMAM dendrimer, M516.68), denoted as PAMAM-(NH₂)₄ for short, was slowly added to a four-neck flask which is equipped with a stirrer, a condenser, a thermometer and a dropping funnel. Temperature was dropped to 5° C. 60.91 g (50%, 0.40 mol methanol solution of carbon bisulfide (M76.14) was slowly added drop by drop. Control the dropping rate to make a temperature of a reaction mixture below 10° C. After the dropping is finished, the temperature was increased to 25° C. to react for 4 hours, white precipitate was separated out, filtered and dried at 60° C. to obtain 40.87 g intermediate formyloxy dithiocarbamates end group polyamidoamine, (denoted as PAMAM-(NHCSSH)₄), M821.24), all of the intermediate dithiocarbamates end group polyamidoamine, (PAMAM-(NHCSSH)₄) was sent to the four-necked flask, 33.50 g water and 20.00 g (40%, 0.20 mol) sodium hydroxide solution was added to react for 2 hours at 50° C., so as to obtain dithiocarbamates end group polyamidoamine with a solid content of 50%, denoted as PAMAM-(DTC)₄, wherein a structural formula is as follows:

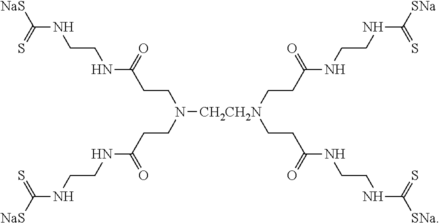

### Example 1

### Preparation of 1-Generation Dithiocarbamates End Group Polyamidoamine Dendritic Polymer

143.00 g (20%, 0.02 mol) methanol solution of (Ethylenediamine core, 1 generation, PAMAM dendrimer, M1429.85), denoted as PAMAM-(NH₂)₈ for short, was slowly added to a four-neck flask which is equipped with a stirrer, a condenser, a thermometer and a dropping funnel. Temperature was dropped to 5° C. 60.91 g (50%, 0.40 mol) methanol solution of carbon bisulfide (M76.14) was slowly added drop by drop. Control the dropping rate to make a temperature of a reaction mixture below 10° C. After the dropping is finished, the temperature was increased to 25° C. to react for 2 hours, white precipitate was separated out, filtered and dried at 60° C. to obtain 40.76 g formyloxy dithiocarbamates end group polyamidoamine, (denoted as PAMAM-(NHCSSH)₈), M2018.97), wherein a yield is 99.95%, which indicates that a molar ratio of amino end group (calculated as -NH₂) and carbon bisulfide which is reacted is (—NH₂):(CS2)=1:1. Mother liquid is a mixture of methanol and unreacted carbon bisulfide and can be recycled.

All of the intermediate dithiocarbamates end group polyamidoamine, PAMAM-(NHCSSH)₈ obtained was sent to the four-necked flask, 35.00 g water and 16.00 g (40%, 0.16 mol) sodium hydroxide solution was added to react for 2 hours at 50° C., so as to obtain dithiocarbamates end group polyamidoamine with a solid content of 50%, denoted as PAMAM-(DTC)₈.

Nuclear magnetic resonance spectroscopy (¹³C NMR) of the PAMAM-(DTC)₈ obtained: 33.23, 33.45, 37.33, 39.68, 42.28, 52.98, 53.22, 55.98, 56.02, 174.56, 175.92, 212.25 ppm, wherein structural formula is as follows:

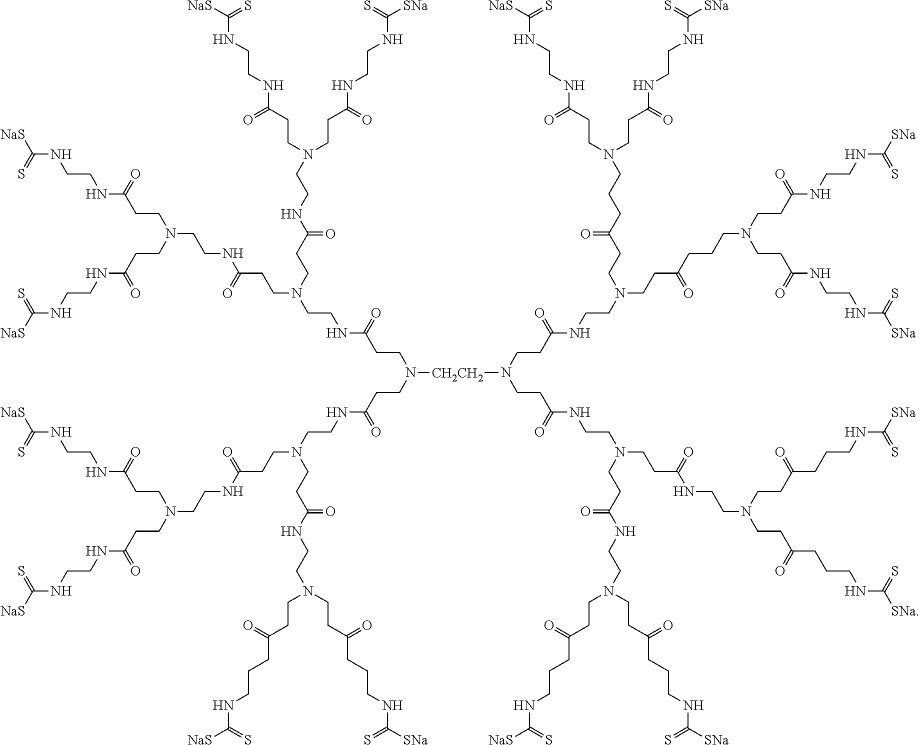

### Example 2

### Preparation of 1-Generation Dithiocarbamates End Group Polyamidoamine Dendritic Polymer

162.81 g (20%, 0.01 mol) methanol solution of (Ethylenediamine core, 2 generation, PAMAM dendrimer, M3256.18), denoted as PAMAM-(NH₂)16 for short, was slowly added to a four-neck flask which is equipped with a stirrer, a condenser, a thermometer and a dropping funnel. Temperature was dropped to 5° C. 73.09 g (50%, 0.48 mol methanol solution of carbon bisulfide (M76.14) was slowly added drop by drop. Control the dropping rate to make a temperature of a reaction mixture below 10° C. After the dropping is finished, the temperature was increased to 25° C. to react for 2 hours, white precipitate was separated out, filtered and dried at 60° C. to obtain 44.71 g formyloxy dithiocarbamates end group polyamidoamine, (denoted as PAMAM-(NHCSSH)₁₆), M4474.42), wherein a yield is 99.93%. Mother liquid is a mixture of methanol and unreacted carbon bisulfide and can be recycled.

All of the intermediate dithiocarbamates end group polyamidoamine, PAMAM-(NHCSSH)₁₆ obtained was sent to the four-necked flask, 42.00 g water and 16.00 g (40%, 0.16 mol) sodium hydroxide solution was added to react for 2 hours at 50° C., so as to obtain dithiocarbamates end group polyamidoamine with a solid content of 50%, denoted as PAMAM-(DTC)₁₆.

Nuclear magnetic resonance spectroscopy (¹³C NMR) of the PAMAM-(DTC)₁₆ obtained: 33.36, 33.56, 33.84, 37.38, 39.61, 39.78, 42.42, 51.98, 52.93, 52.96, 55.32, 55.76, 56.63, 175.46, 175.89, 176.22, 212.75 ppm, wherein structural formula is as follows:

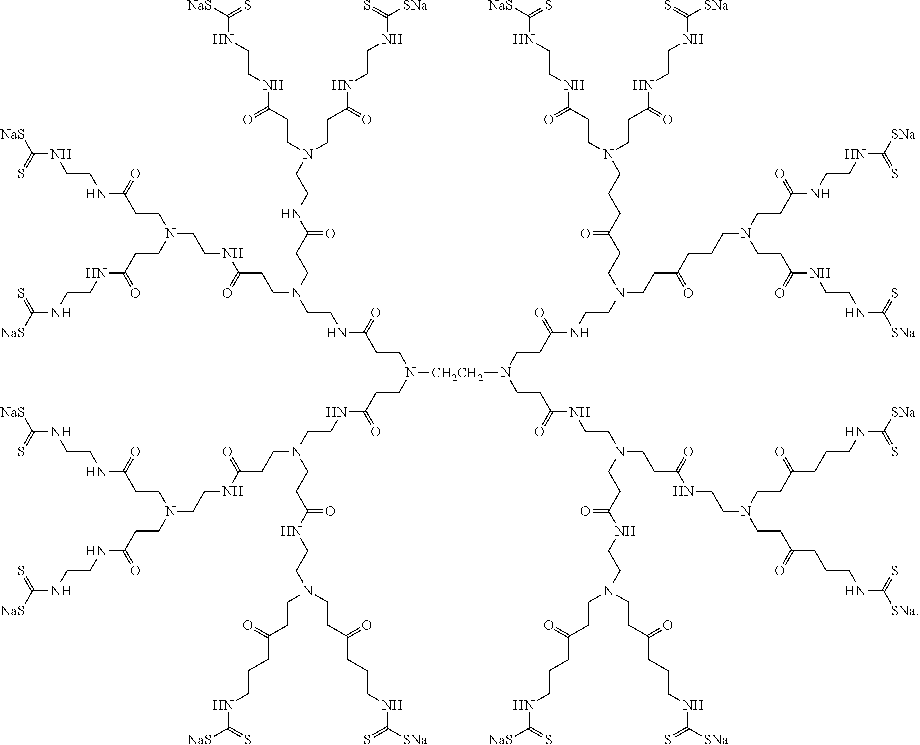

### Example 3

### Treatment of Circuit-Board (PCB) Heavy Metal Wastewater

Wastewater of a circuit board: pH_{2.6,} Cu²⁺165.282 mg/19 L⁻¹Ni²⁺101.395 mg·L⁻¹, heavy metal precipitant in the example 1 and 2 is added, stir for 5 minutes, deposit for 5 minutes, filter to measure metal concentration and the result is as shown in Table. 1.

The result indicates that when adding amount of the heavy metal precipitant is 200 mg·L⁻¹, the PAMAM-(DTC)₈ and PAMAM-(DTC)₁₆ in the example 1 and the example 2 is capable of reaching “Discharge Standard of Industrial Sources of Copper, Cobalt and Nickel (GB25467-2010)” and “Town Integrated Wastewater Discharge Standard (GB18918-2002)”, but the PAMAM-(DTC)4 obtained in the comparative example is not capable of achieving. When adding amount of the PAMAM-(DTC)4 obtained in the comparative example is 250 mg·L⁻¹, the wastewater is capable of reaching “Discharge Standard of Industrial Sources of Copper, Cobalt and Nickel (GB25467-2010)”, but fails to reach the “Town Integrated Wastewater Discharge Standard (GB18918-2002)”.

Seen from appearances, the deposition formed by the heavy metals and the PAMAM-(DTC)₈ and PAMAM-(DTC)₁₆ in the preferred embodiment 1 and 2 of the present invention has large and dense particles and high sedimentation velocity. However, the deposition formed by the heavy metals and the PAMAM-(DTC)4 by the comparative example has large and loose particles and low sedimentation velocity.

TABLE 1
Content of Gu and Ni before and after treatment

| | Agentia | | |
|---|---|---|---|
| | concentration/ | Cu²⁺/ | Ni²⁺/ |
| Precipitant | mg · L⁻¹ | mg · L⁻¹ | mg · L⁻¹ |
| Before treatment | 0 | 165.282 | 101.395 |
| Example 1 | 150 | 9.193 | 16.154 |
| PAMAM-(DTC)₈ | 200 | 0.024 | 0.032 |
| Example 2 | 150 | 10.565 | 13.914 |
| PAMAM-(DTC)₁₆ | 200 | 0.011 | 0.025 |
| Comparative example | 150 | 35.284 | 43.264 |
| PAMAM-(DTC)₄ | 200 | 9.683 | 12.393 |
| | 250 | 0.094 | 0.492 |

| | | |
|---|---|---|
| Discharge Standard of Industrial | 0.2 | 0.5 |
| Sources of Copper, Cobalt and Nickel | | |
| (GB25467-2010) | | |
| Town Integrated Wastewater | 0.5 | 0.05 |
| Discharge Standard (GB18918-2002) | | |

### Example 4

### Complexed Lead-Containing Wastewater

The heavy metal precipitant in the example 1 and the comparative example was added to EDTA complexed lead-containing wastewater: pH_{2.26,} Pb²⁺50.02 mg·L⁻¹, stir for 5 min, precipitate 5 min and filter. Concentration of heavy metals is measured and the result is as shown in Table. 2.

The result shows that when adding amount of PAMAM-(DTC)₈ in the example 1 is 150 mg·L⁻¹, discharge standard of GB25467-2010 and GB18918-2002 was reached; when adding amount of PAMAM-(DTC)4 is 200 mg·L⁻¹, discharge standard of GB25467-2010 could be reached, GB18918-2002 could not be reached.

Meanwhile, it can be seen that the deposition formed by PAMAM-(DTC)₈ in the example 1 and lead is large in volume, dense and has a large sedimentation velocity. The deposition formed by PAMAM-(DTC)₄ in the comparative example is large in volume, loose and flaky, and the sedimentation velocity is relatively slow.

Ends of over 1.0 generation PAMAM-(DTC)₈ has 8 end group, the PAMAM-(DTC)₈ is a dendrimer with three-dimensional structure in space, thus the PAMAM-(DTC)₈ is capable of forming large chelate deposition in a net structure with heavy metals, wherein the sedimentation velocity is fast. Ends of the 0 generation PAMAM-(DTC)₄ has four end group, and the PAMAM-(DTC)₄ is a planar hyperbranched star with two-dimensional structure, although the volume thereof is large, the sedimentation velocity is relatively slow.

TABLE 2
Content of Gu and Ni before and after treatment

| | Agentia | |
|---|---|---|
| | concentration/ | Pb²⁺/ |
| Precipitant | mg · L⁻¹ | mg · L⁻¹ |
| Before treatment | 0 | 50.02 |
| Example 1 | 100 | 6.615 |
| PAMAM-(DTC)₈ | 150 | 0.018 |
| Comparative example | 100 | 22.326 |
| PAMAM-(DTC)₄ | 150 | 10.399 |
| | 200 | 0.137 |

| | |
|---|---|
| Discharge Standard of Industrial Sources of Copper, | 0.2 |
| Cobalt and Nickel (GB25467-2010) | |
| Town Integrated Wastewater Discharge Standard | 0.1 |
| (GB18918-2002) | |

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A dendrimer heavy metal precipitant with double functions of chelation and self-flocculation and its application, wherein the heavy metal precipitant is a terminal dithiocarbamate polyamidoamine dendrimer with the terminal chelating group dithiocarbamates, the number of the dithiocarbamates is 8 times that of the G (G is generation, G≠0, G=1-3), wherein a structural formula thereof is as shown in formula I: [symbol]
wherein “A” represents a core which is specified as [N(CH₂)_{2˜12}N]; “—” represents a branched chain which is specified as [CH₂CH₂CONHCH₂CH₂]; “N” represents an internal branched atom which is specified as a nitrogen atom; “G” represents generations which is specified as a positive number between 1-3.

2. The dendritic-polymer heavy metal precipitant according to claim 1, wherein the dendrimer heavy metal collector with double functions of chelation and self-flocculation is prepared by a reaction of a raw material of polyamidoamine has terminal amine groups with an amount of 8 times that of the G (G≠0, G=1-3) and carbon bisulfide;
wherein the amount of the terminal amine groups is 8 times that of the G (G≠0, G=1-3); a structural formula is as shown in formula II: [symbol]
wherein “A” represents a core which is specified as [N(CH₂)_{2˜12}N]; “—” represents a branched chain which is specified as [CH₂CH₂CONHCH₂CH₂]; “N” represents an internal branched atom which is specified as a nitrogen atom; “G” represents generations which is specified as a positive number between 1-3.

3. A method for removing heavy metals in heavy metal wastewater or complexing form heavy metal wastewater comprising introducing the dendritic-polymer heavy metal precipitant with double functions of chelation and self-flocculation as recited in claim 1.

4. A method for stably treating on heavy metals in municipal solid waste incineration fly ash and stably restoring heavy metals in contaminated soil.
